(19) United States
(12) Patent Application Publication
(10) Pub. No.: US 2020/0342450 A1
(43) Pub. Date: Oct. 29, 2020

(54) DIGITAL WALLET

(71) Applicant: BEIJING DIDI INFINITY TECHNOLOGY AND DEVELOPMENT CO., LTD., Beijing (CN)

(72) Inventor: Rui GE, Beijing (CN)

(73) Assignee: BEIJING DIDI INFINITY TECHNOLOGY AND DEVELOPMENT CO., LTD., Beijing (CN)

(21) Appl. No.: 16/925,374

(22) Filed: Jul. 10, 2020

Related U.S. Application Data
(63) Continuation of application No. PCT/CN2018/101626, filed on Aug. 22, 2018.

(51) Int. Cl. G06Q 20/36; G06Q 50/30; G06Q 40/02; G06Q 20/10; G06Q 20/12; G06Q 20/32; G06Q 20/22; G06Q 30/02; G01S 19/51

(52) U.S. Cl. CPC G06Q 20/3676; G06Q 50/30; G06Q 40/025; G06Q 20/108; G01S 19/51; G06Q 20/3221; G06Q 20/227; G06Q 20/3223; G06Q 30/0284; G06Q 20/127

(57) ABSTRACT

A computer-implemented method for providing digital wallet comprises obtaining, from a computing device, information of a transportation, the information comprising: a starting time of the transportation, an ending time of the transportation, an origin of the transportation, and/or a destination of the transportation; performing: a comparison of the starting time with a first time range, a comparison of the ending time with a second time range, a comparison of the origin with an origin location range, and/or a comparison of the destination with a destination location range; and in response to determining: the starting time is within the first time range, the ending time is within the second time range, the origin is within the origin location range, and/or the destination is within the destination location range, allowing the computing device to use at least a portion of a credit from a digital wallet account for defraying the transportation's cost.

### CROSS-REFERENCE TO RELATED APPLICATIONS

This application is a continuation of International Application No. PCT/CN2018/101626, filed on Aug. 22, 2018, the entire contents of which are hereby incorporated by reference.

### FIELD OF THE INVENTION

This disclosure generally relates to computer technology, and in particular, to digital wallet.

### BACKGROUND

Company employees routinely need transportation for business-related purposes. Traditionally, the employee will have to spend personal funds to pay for the transportation cost and apply for reimbursement from the company. Such process is complicated and time-consuming.

### SUMMARY

Various embodiments of the present disclosure include systems, methods, and non-transitory computer readable media for providing digital wallet.

According to one aspect, a computer-implemented method for providing digital wallet comprises: obtaining, from a computing device, information of a transportation, the information comprising at least one of: a starting time of the transportation, an ending time of the transportation, an origin of the transportation, or a destination of the transportation, performing at least one of: a comparison of the starting time with a first time range, a comparison of the ending time with a second time range, a comparison of the origin with an origin location range, or a comparison of the destination with a destination location range, and in response to determining at least one of: the starting time is within the first time range, the ending time is within the second time range, the origin is within the origin location range, or the destination is within the destination location range, allowing the computing device to use at least a portion of a credit from a digital wallet account for defraying the transportation's cost.

In some embodiments, obtaining the origin of the transportation comprises obtaining a Global Positioning System (GPS) position of the computing device corresponding to a pick-up location of the transportation.

In some embodiments, obtaining the destination of the transportation comprises obtaining a GPS location of another computing device associated with a vehicle providing the transportation corresponding to a drop-off location of the transportation.

In some embodiments, the method further comprises: determining a recipient of the portion of the credit, and in response to determining that the recipient is not associated with a provider of the transportation, preventing the computing device from using the portion of the credit.

In some embodiments, before obtaining, from the computing device, the information of the transportation, the method further comprises: issuing the credit from a master account to the digital wallet account accessible from the computing device, wherein the credit is associated with at least one of: the first time range, the second time range, the origin location range, or the destination location range.

In some embodiments, the credit is not usable beyond an effective time period, and the method further comprises: when the effective time expires, returning a remaining amount of the credit in the digital wallet account to the master account. In one example, the master account is associated with an enterprise entity, and the first time range, the second time range, the origin location range, and the destination location range are configured by the enterprise entity.

In some embodiments, the digital wallet account and a personal payment account are accessible through the computing device, and allowing the computing device to use at least the portion of the credit for defraying the transportation's cost comprises providing options through the computing device to pay for the transportation's cost from at least one of the digital wallet account or the personal payment account.

In one example, providing options through the computing device to pay for the transportation's cost from at least one of the digital wallet account or the personal payment account comprises: providing an option for paying a first portion of the transportation's cost from the digital wallet account and a second portion of the transportation's cost from the personal payment account.

In another example, in response to determining that a remaining amount of the credit in the digital wallet account is less than the transportation's cost, drawing the remaining amount to pay for a part of the transportation's cost and drawing a balance of the transportation's cost from the personal payment account.

In another example, allowing the computing device to use at least the portion of the credit for defraying the transportation's cost comprises allowing the computing device to defray the transportation's cost with the credit for no more than a threshold.

In another example, the transportation is provided by a vehicle associated with another computing device, wherein a driver account is accessible from the another computing device, and the method further comprises depositing a refund from the driver account for the transportation into the digital wallet account.

According to another aspect, a digital wallet system, comprising a processor and a non-transitory computer-readable storage medium storing instructions that, when executed by the processor, cause the processor to perform a method. The method comprises: obtaining, from a computing device, information of a transportation, the information comprising at least one of: a starting time of the transportation, an ending time of the transportation, an origin of the transportation, or a destination of the transportation, performing at least one of: a comparison of the starting time with a first time range, a comparison of the ending time with a second time range, a comparison of the origin with an origin location range, or a comparison of the destination with a destination location range, and in response to determining at least one of: the starting time is within the first time range, the ending time is within the second time range, the origin is within the origin location range, or the destination is within the destination location range, allowing the computing device to use at least a portion of a credit from a digital wallet account for defraying the transportation's cost.

According to another aspect, a computer-implemented method for providing digital wallet comprises: transmitting, by a computing device, information of a transportation to a server, the information comprising at least one of: a starting time of the transportation, an ending time of the transportation, an origin of the transportation, or a destination of the transportation, to cause the server to determine at least one of: the starting time is within the first time range, the ending time is within the second time range, the origin is within the origin location range, or the destination is within the destination location range, and in response to receiving an allowance from the server, using at least a portion of a credit from a digital wallet account for defraying the transportation's cost.

In some embodiments, transmitting the origin of the transportation comprises transmitting a Global Positioning System (GPS) position of the computing device corresponding to a pick-up location of the transportation.

In some embodiments, the method further comprises displaying an option for paying a first portion of the transportation's cost from the digital wallet account and a second portion of the transportation's cost from a personal payment account.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary environment for digital wallet, in accordance with various embodiments.

FIG. 2 illustrates an exemplary system interaction for digital wallet, in accordance with various embodiments.

FIGS. 3A-3C illustrate exemplary interfaces of a digital wallet, in accordance with various embodiments.

FIG. 4A illustrates a flowchart of an exemplary method for providing digital wallet, in accordance with various embodiments.

FIG. 4B illustrates a flowchart of another exemplary method for providing digital wallet, in accordance with various embodiments.

FIG. 5 illustrates a block diagram of an exemplary computer system in which any of the embodiments described herein may be implemented.

### DETAILED DESCRIPTION

Company employees routinely need transportation for business-related purposes. Traditionally, the employee will have to spend personal funds to pay for the transportation cost and apply for reimbursement from the company. Some company officer screens these applications and makes a reimbursement decision. Such process is complicated and time-consuming. Notwithstanding, if the company chooses to pre-distribute a certain amount of credit to the employees, tracking and managing the use of the credit is difficult and almost practically impossible with an increasing number of employees, as the company strives to ensure specific usage of the credit, for example, to only pay for business-related transportation.

The disclosed systems and methods can at least mitigate the above-described technical problems of current practice. Various embodiments of the present disclosure include systems, methods, and non-transitory computer readable media for providing digital wallet (alternatively referred to as enterprise wallet). The digital wallet may be implemented as an employee account accessible from the employee's mobile phone, to which the an enterprise entity (e.g., manager) of the company may issue credit to the digital wallet. The credit may be associated with rules configured by the enterprise entity, for example, the credit can only be used for over-time transportation, business travel reimbursement, etc. When the employee tries to use the credit, information such as the transportation time and location is collected and verified to determine if the associated rules are broken. Through the disclosed system, the credit usage can be efficiently tracked and managed by the enterprise, and misuses and abuses can be prevented.

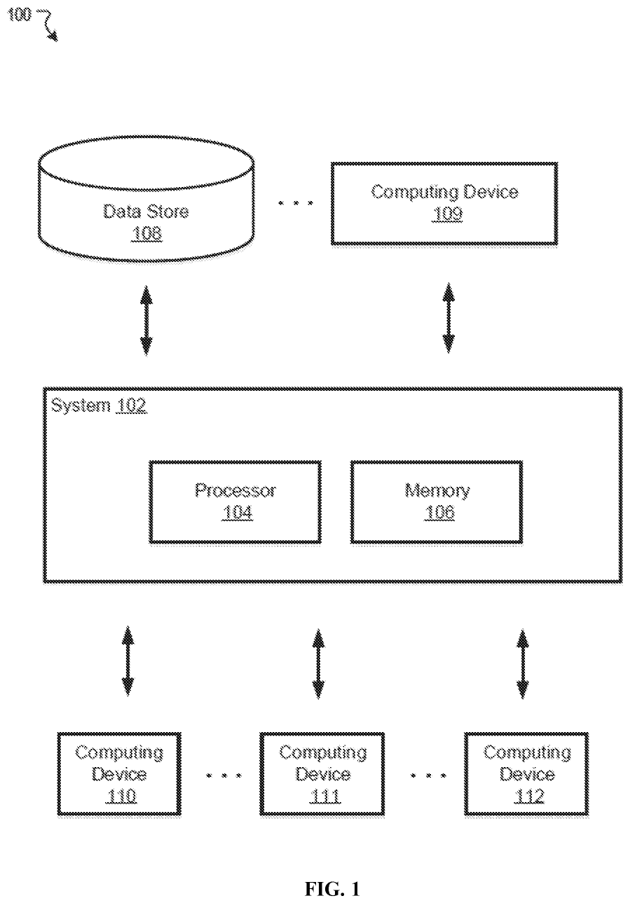

FIG. 1 illustrates an exemplary environment 100 for providing digital wallet, in accordance with various embodiments. As shown in FIG. 1, the exemplary environment 100 can comprise at least one computing system 102 that includes one or more processors 104 and memory 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phone, tablet, server, computer, wearable device, etc. The system 102 above may be installed with appropriate software and/or hardware (e.g., wires, wireless connections, etc.) to access other devices of the environment 100.

The environment 100 may include one or more data stores (e.g., a data store 108) and one or more computing devices (e.g., a computing device 109) that are accessible to the system 102. In some embodiments, the system 102 may be configured to obtain data (e.g., map data, user data) from and/or store data into the data store 108 (e.g., user dataset, map database) and/or the computing device 109 (e.g., computer, server, mobile phone).

The environment 100 may further include one or more computing devices (e.g., computing devices 110, 111, and 112) coupled to the system 102. The each computing device may be, for example, mobile phone, tablet, computer, wearable device (smart watch), etc. The computing devices may each transmit data to and/or receive data from the system 102. The transmitted data may comprise user profile data, time data, location data, etc. The location data may comprise GPS (Global Positioning System) coordinates. The computing device 110 may be associated with a user (e.g., a company employee who is also a passenger of a transportation). The computing device 111 may be associated with a driver (e.g., a driver driving a vehicle for the transportation). The computing device 112 may be associated with an enterprise entity (e.g., a manager of the company). The computing devices 110, 111, and 112 may have different interfaces and functions tailored for corresponding user groups.

In some embodiments, the system 102 may implement an online information or service platform (e.g., in the form of a software application described herein). The platform may be referred to as a vehicle platform (or service hailing platform, ride order dispatching platform). The service may be associated with vehicles (e.g., cars, bikes, boats, airplanes, etc.). The platform may accept requests for transportation, identify vehicles to fulfill the requests, arrange for pick-ups, and process transactions. For example, a user may use the computing device 110 (e.g., a mobile phone installed with the software application associated with the platform) to request transportation from the platform. The system 102 may receive the request (e.g., including a pick-up time, a pick-up location, and a destination) and relay it to various vehicle drivers (e.g., by posting the request to mobile phones carried by the drivers). A vehicle driver may use the computing device 111 (e.g., another mobile phone installed with the application associated with the platform) to accept the posted transportation request, proceed to the pick-up location, and transport the user to the destination. Fees (e.g., transportation fees) can be transacted among the system 102 and the computing devices 110 and 111. Some platform data may be stored in the memory 106 or retrievable from the data store 108 and/or the computing devices 109, 110, and 111. For example, for each trip, the locations of the origin and destination (e.g., transmitted by the computing devices 110 and/or 111), the fee, and the time can be obtained by the system 102.

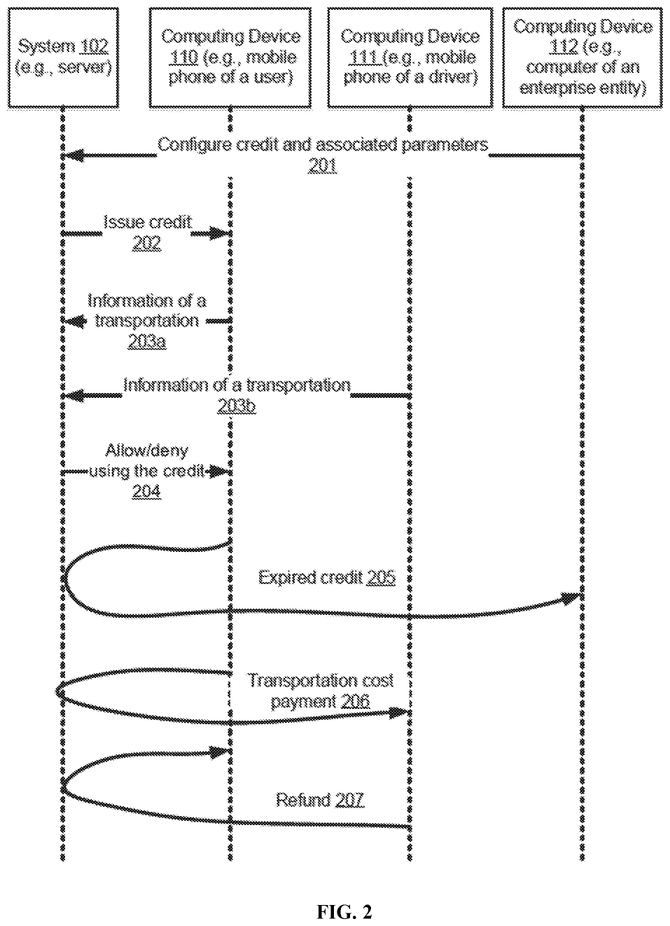

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as single devices or multiple devices coupled together. The system 102 may be implemented as a single system or multiple systems coupled to each other. In general, the system 102, the computing device 109, the data store 108, and the computing device 110, 111, and 112 are able to communicate with one another through one or more wired or wireless networks (e.g., the Internet) through which data is communicated. Various aspects of the environment 100 are described below in reference to FIG. 2 to FIG. 5.

FIG. 2 illustrates an exemplary system interaction for digital wallet, in accordance with various embodiments. The operations shown in FIG. 2 and presented below are intended to be illustrative. Depending on the implementation, the operations shown in FIG. 2 and presented below may include additional, fewer, or alternative steps performed in various orders or in parallel.

FIG. 2 illustrates a system 102 (e.g., server), a computing device 110 (e.g., mobile phone used by a user), a computing device 111 (e.g., mobile phone used by a driver), and a computing device 112 (e.g., computer of an enterprise entity) described above with reference to FIG. 1. The user may be an employee of or otherwise associated with a company (also referred to as enterprise). The company and enterprise are defined broadly and may include any type of organization or a group of organizations. The enterprise entity may be a manager or another officer of the company. For example, the computing device 112 may be a back-end computer of the company. Alternatively, the computing device 112 may be a computing device having access to a master account. For example, the computing device 112 may be the manager's personal mobile phone and can access a master account of the company for managing credit distribution.

In some embodiments, the computing devices 110, 111, and 112 may each be installed with a software (e.g., mobile phone APP, desktop software) for the vehicle platform. The software may have different interfaces and functions on different computing devices. For example, the computing device 110 may install a passenger-end software version, and the user may access the software by logging into a user account. The computing device 111 may install a driver-end software version, and the driver may access the software by logging into a driver account. The computing device 112 may install an enterprise-end software version, and the enterprise entity may access the software by logging into an enterprise account. The software installed on the computing devices 110 and 111 may provide the vehicle hailing function described above. The software installed on the computing devices 110, 111, and 112 may provide the digital wallet function discussed in more details below.

FIG. 2 illustrates interactions among the system 102 and the computing devices 110, 111, and 112. The operations of the interaction presented below are intended to be illustrative. Depending on the implementation, the operations may include additional, fewer, or alternative steps performed in various orders or in parallel.

In some embodiments, at step 201, the computing device 112 may configure a credit for distribution and one or more associated rules for the credit. At step 202, based on the configuration, the system 102 may issue the credit from a master account to a digital wallet account. The master account is accessible from the enterprise-end software on the computing device 112, and the digital wallet account is accessible from the user-end software on the computing device 110. The master account may be a company account, and the company entity may distribute credits from the master account to one or more digital wallet accounts of employees. The digital wallet account may be bundled with the user account and available through the user-end software.

In some embodiments, through options provided by the enterprise-end software, the enterprise entity may configure the one or more rules to associate with the credit. The rules may specify that the credit may be spent only for qualified transportations (e.g., over-time ride to home, business travel transportation, etc.). To that end, the rules may further specify a first time range (within which a qualified transportation may commence), a second time range (within which a qualified transportation may end), an origin location range (within which the user may be picked up for a qualified transportation), and/or a destination location range (within which the user may be dropped off for a qualified transportation). For example, for over-time reimbursement, the first time range can be after 9 pm (same for all employees), the origin location range can be 1 mile radius from the company (same for all employees), and the destination location range can be 1 mile radium for the home address (tailored for each employee). That is, the specified parameters in the rules may be the same or differ from employee to employee. Thus, the credit may be configured to associate with: the first time range, the second time range, the origin location range, and/or the destination location range. Optionally, the rules may comprise other conditions such as a threshold of a credit amount that can be spent for a qualified transportation, a threshold of usage frequency (e.g., maximum once per day), an expiration date of the credit, a proportion of the transportation's cost that can be paid by the credit, etc.

In some embodiments, when the user tries to use the credit, the user may use the computing device 110 to hail a service vehicle to provide transportation. The system may obtain information of the transportation to verify if the associated rules are satisfied. For example, at step 203a and 203b, the system 102 may obtain, from the computing device 110 and/or the computing device 203b, information of a transportation, the information comprising: a starting time of the transportation, an ending time of the transportation, an origin of the transportation, and/or a destination of the transportation. The information may be obtained before, during, and/or after the transportation is completed. For example, before the transportation takes place, the obtained information may comprise a planned starting time, an planned ending time, a planned origin, and/or a planned destination inputted by the user for the planned trip. For example, after the transportation is completed, the obtained information may comprise, a real starting time, a real ending time, a real origin, and a real destination for the completed trip.

That is, the computing device 110 may transmit information of a transportation to the system 102 (e.g., server), the information comprising: a starting time of the transportation, an ending time of the transportation, an origin of the transportation, and/or a destination of the transportation, to cause the server to determine: the starting time is within the first time range, the ending time is within the second time range, the origin is within the origin location range, and/or the destination is within the destination location range, and in response to receiving an allowance from the server, use at least a portion of a credit from a digital wallet account for defraying the transportation's cost.

In some embodiments, for the transportation, the computing device 110 may indicate a pick-up location and transmit the location to the computing device 111 via the system 102. This location may be used as the pick-up location. Additionally or alternatively, when the user is picked up, the driver may indicate through the driver-end software that the user is picked up, and the current location of either computing device 110 or 111 can also be used as the origin of the transportation. When the destination is arrived, the driver may indicate through the driver-end software that the user is dropped off, and the current location of either computing device 110 or 111 can also be used as the destination of the transportation. In one example, to obtain the origin of the transportation, the system 102 may obtain a Global Positioning System (GPS) position of the computing device 110 or the computing device 111 corresponding to a pick-up location of the transportation. The computing device 110 may transmit the GPS position of the computing device corresponding to the pick-up location of the transportation. In another example, to obtain the destination of the transportation, the system 102 may obtain a GPS location of the computing device 110 or the computing device 111 associated with a vehicle providing the transportation corresponding to a drop-off location of the transportation.

In some embodiments, at step 204, the system 102 may determine if allow or deny the use of the credit by the computing device 110. For example, the system 102 may perform: a comparison of the starting time with a first time range, a comparison of the ending time with a second time range, a comparison of the origin with an origin location range, and/or a comparison of the destination with a destination location range. In response to determining that: the starting time is within the first time range, the ending time is within the second time range, the origin is within the origin location range, and/or the destination is within the destination location range, the system 102 may allow the computing device to use at least a portion of the credit from the digital wallet account for defraying the transportation's cost (entirely or partially). Thus, the user may only use the credit for specific purposes defined by the rules, and credit abuses and misuses can be prevented.

In some embodiments, the system 102 may limit the disbursement of the credit to a provider of the transportation. For example, since the system 102 registers the transportation initiated by the user and has information of the driver providing the ride, the system 102 may verify if the receiving end of the credit is the driver's account, preventing fraudulent credit uses. Thus, the system may determine a recipient of the portion of the credit, and in response to determining that the recipient is not associated with a provider of the transportation, prevent the computing device 110 from using the portion of the credit.

In some embodiments, the enterprise entity may configure an expiration date for the credit, such that the credit is not usable before and/or beyond the effective time period. When the effective time expires, the system 102 may return a remaining amount of the credit (e.g., expired credit 205) in the digital wallet account back to the master account.

In some embodiments, the digital wallet account as well as a personal payment account are accessible through the computing device 110. That is, the user may have both accounts, and the personal payment account is not associated with the company. To allow the computing device 110 to use at least the portion of the credit for defraying the transportation's cost, the system 102 may provide options through the computing device 110 to pay for the transportation's cost from the digital wallet account and/or the personal payment account.

In one example, to provide options to pay for the transportation's cost from the digital wallet account and/or the personal payment account, the system 102 may provide an option through the computing device 110 for paying a first portion of the transportation's cost from the digital wallet account and a second portion of the transportation's cost from the personal payment account. The computing device 110 may display an option for paying the first portion of the transportation's cost from the digital wallet account and the second portion of the transportation's cost from the personal payment account. For instance, the user can input an proportion (e.g., 50%) splitting the transportation's cost to draw from the digital wallet account and the personal payment account according to the proportion. The payments from both accounts may be referred to transportation cost payment 206. Alternatively, the enterprise entity may have specified in the rules a proportion of the transportation's cost (e.g., up to 50%) that can be paid from the credit for each ride. The user may accordingly choose an amount within the allowed range to pay the transportation's cost with the credit from the digital wallet, and pay the rest from the personal payment account.

In another example, in response to determining that a remaining amount of the credit in the digital wallet account is less than the transportation's cost, the system 102 may draw the remaining amount to pay for a part of the transportation's cost and draw a balance of the transportation's cost from the personal payment account. For instance, if the transportation's cost is 20 dollars and the remaining credit in the digital wallet account is 15 dollars, the system 102 may draw the 15 dollars from the digital wallet account and the rest 5 dollars from the personal payment account.

In another example, the system 102 may allow the computing device to defray the transportation's cost with the credit for no more than a threshold. As discussed above, the enterprise entity may configure a threshold of a credit amount that can be spent for a qualified transportation, and this threshold can limit the credit disbursement for each transportation. For instance, the enterprise entity may estimate that an over-time ride home should not exceed 100 dollars in cost, and can therefore impose such threshold in the rules.

In some embodiments, the transportation is provided by a vehicle associated with another computing device (e.g., the computing device 111), and a driver account is accessible from the another computing device. The system 102 may deposit a refund (e.g., refund 207) from the driver account for the transportation into the digital wallet account, for example, when the driver or the system 102 makes a refund for any reason.

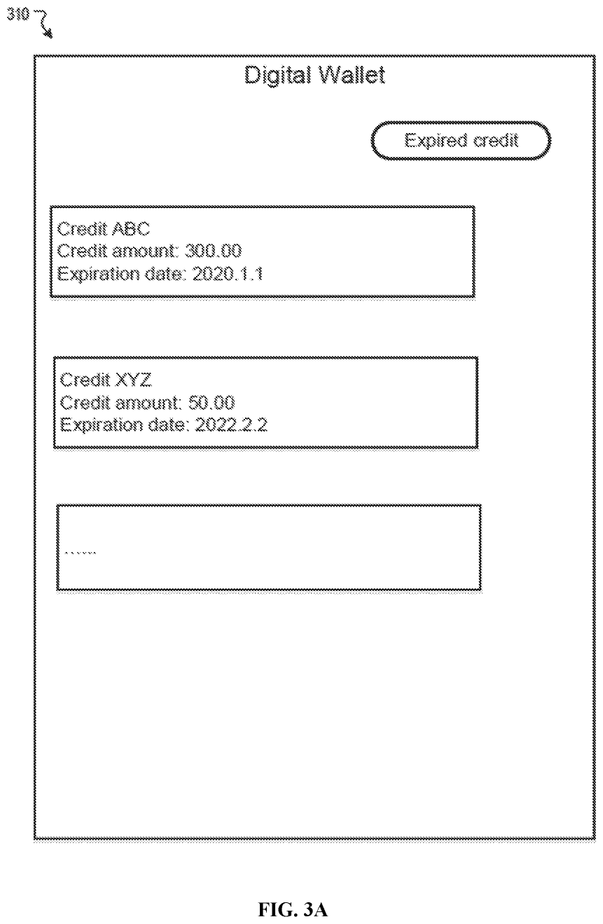

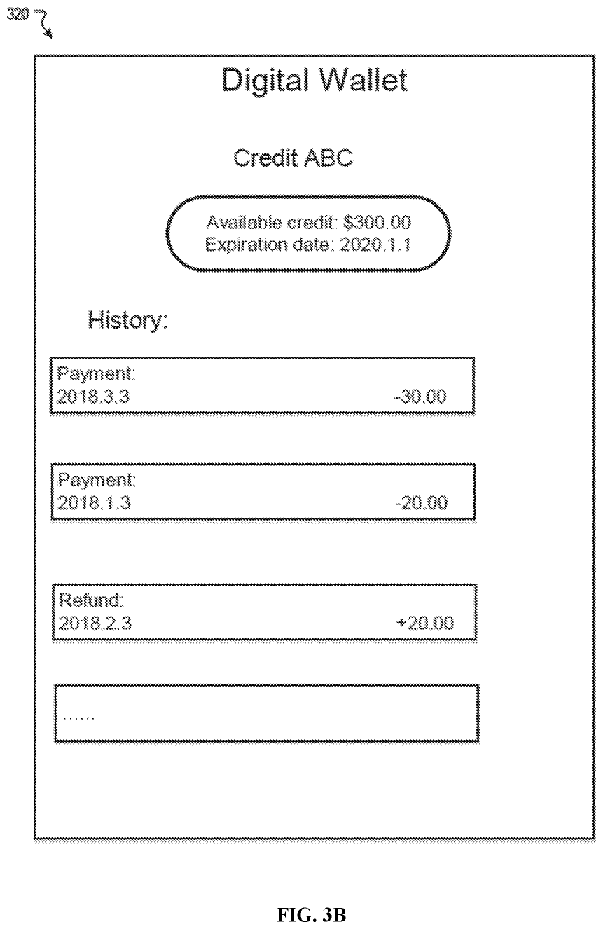

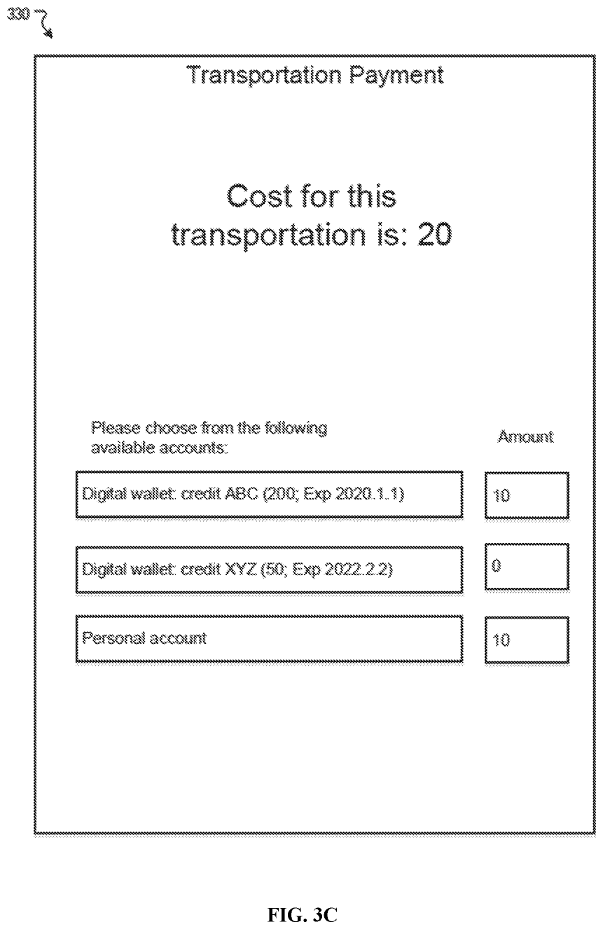

FIGS. 3A-3C illustrate exemplary interfaces of an application for providing digital wallet, in accordance with various embodiments. The exemplary interfaces may be rendered on the computing device 110. The operations shown in FIGS. 3A-3C and presented below are intended to be illustrative.

As shown in FIG. 3A, an interface 310 may render information of all credits available and unavailable. For example, a credit ABC may be issued by the user's employer at one time, a credit XYZ may be issued by the user's employer at another time, and expired credits can be found from the “expired credit” tab. Each available credit may be associated with a credit amount and an expiration date.

As shown in FIG. 3B, an interface 320 may render information of the credit usage history for each available or unavailable credit. As shown, the historical usage of credit ABC is listed, indicating past payment disbursement amount and date, and past refund amount and date.

As shown in FIG. 3C, an interface 330 may provide options for paying for the transportation's cost from one or more accounts. As shown, two accounts are available for paying the 20 dollar transportation cost: the digital wallet account and the personal account. From the digital wallet, two credits are available for payment: credit ABC and credit XYZ. The user may use any combination to make up the payment, as long as there is sufficient fund in the account and the rules for the credit usage are not broken. For example, here, the user may draw 50% of the cost (10 dollars) from the credit ABC in the digital wallet, and the rest 50% (10 dollars) from the personal account.

As described, the company can easily configure and manage credit distribution and tracking from the enterprise-end software, with assurance that the computing system verifies the credit usage in accordance with the specified rules. The user is provided with convenience and flexibility to spend the credit. Thus, credit misuses, abuses, and fraud can be prevented, and the purpose of credit distribution is served. Company resources previously spent on credit management can now be conserved and put in use elsewhere.

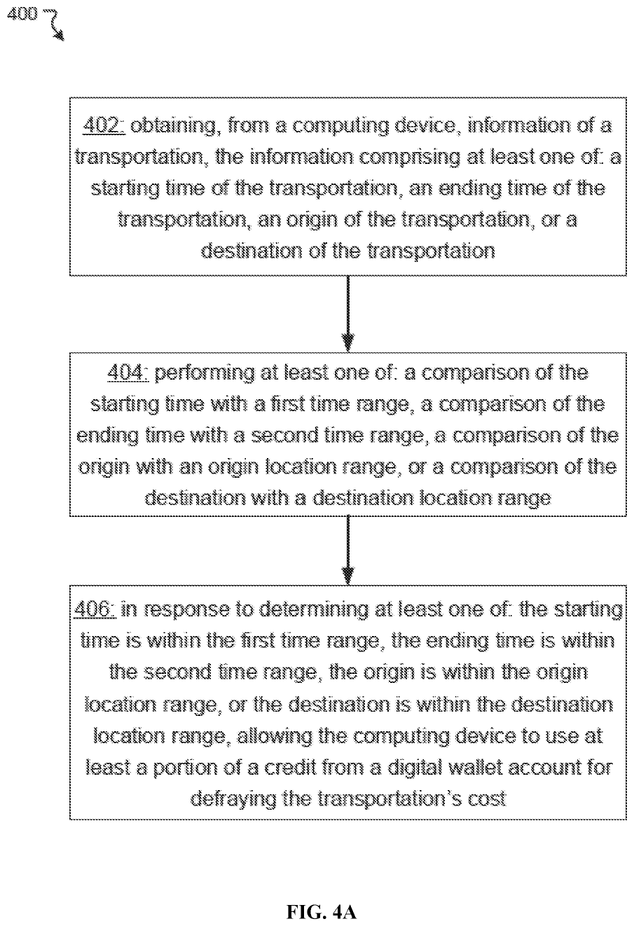

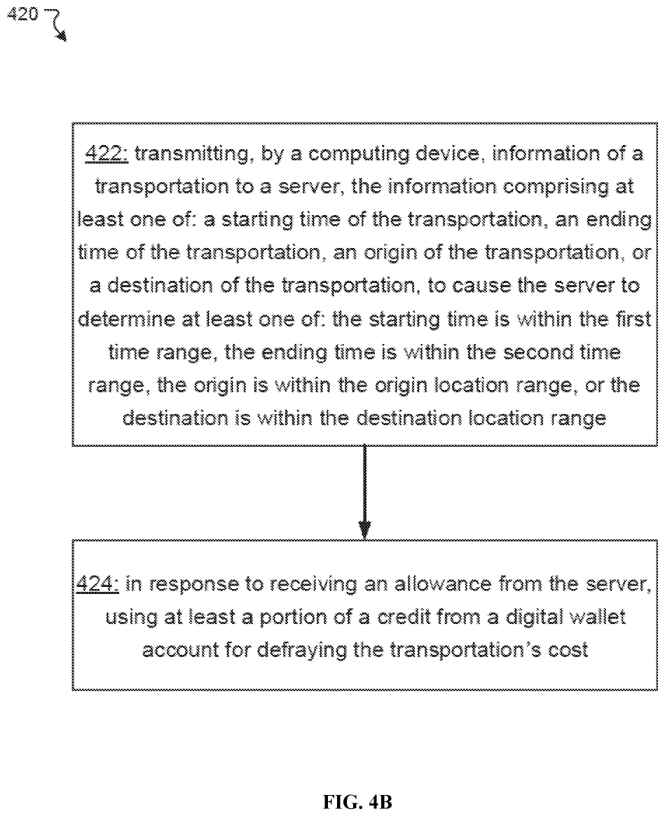

FIG. 4A illustrates a flowchart of an exemplary method 400 for providing digital wallet, according to various embodiments of the present disclosure. The method 400 may be implemented in various environments including, for example, the environment 100 of FIG. 1. The exemplary method 400 may be implemented by one or more components of the system 102 (e.g., the processor 104, the memory 106). An exemplary system 102 may include a server. The exemplary method 400 may be implemented by multiple systems similar to the system 102. The operations of method 400 presented below are intended to be illustrative. Depending on the implementation, the exemplary method 400 may include additional, fewer, or alternative steps performed in various orders or in parallel.

Block 402 comprises obtaining, from a computing device (e.g. the computing device 110), information of a transportation, the information comprising at least one of: a starting time of the transportation, an ending time of the transportation, an origin of the transportation, or a destination of the transportation. Block 404 comprises performing at least one of: a comparison of the starting time with a first time range, a comparison of the ending time with a second time range, a comparison of the origin with an origin location range, or a comparison of the destination with a destination location range. Block 406 comprises in response to determining at least one of: the starting time is within the first time range, the ending time is within the second time range, the origin is within the origin location range, or the destination is within the destination location range, allowing the computing device to use at least a portion of a credit from a digital wallet account for defraying the transportation's cost.

In some embodiments, obtaining the origin of the transportation comprises obtaining a Global Positioning System (GPS) position of the computing device corresponding to a pick-up location of the transportation.

In some embodiments, obtaining the destination of the transportation comprises obtaining a GPS location of another computing device associated with a vehicle providing the transportation corresponding to a drop-off location of the transportation.

In some embodiments, the method further comprises: determining a recipient of the portion of the credit, and in response to determining that the recipient is not associated with a provider of the transportation, preventing the computing device from using the portion of the credit.

In some embodiments, before obtaining, from the computing device, the information of the transportation, the method further comprises: issuing the credit from a master account to the digital wallet account accessible from the computing device, wherein the credit is associated with at least one of: the first time range, the second time range, the origin location range, or the destination location range.

In some embodiments, the credit is not usable beyond an effective time period, and the method further comprises: when the effective time expires, returning a remaining amount of the credit in the digital wallet account to the master account. In one example, the master account is associated with an enterprise entity, and the first time range, the second time range, the origin location range, and the destination location range are configured by the enterprise entity.

In some embodiments, the digital wallet account and a personal payment account are accessible through the computing device, and allowing the computing device to use at least the portion of the credit for defraying the transportation's cost comprises providing options through the computing device to pay for the transportation's cost from at least one of the digital wallet account or the personal payment account.

In one example, providing options through the computing device to pay for the transportation's cost from at least one of the digital wallet account or the personal payment account comprises: providing an option for paying a first portion of the transportation's cost from the digital wallet account and a second portion of the transportation's cost from the personal payment account.

In another example, in response to determining that a remaining amount of the credit in the digital wallet account is less than the transportation's cost, drawing the remaining amount to pay for a part of the transportation's cost and drawing a balance of the transportation's cost from the personal payment account.

In another example, allowing the computing device to use at least the portion of the credit for defraying the transportation's cost comprises allowing the computing device to defray the transportation's cost with the credit for no more than a threshold.

In another example, the transportation is provided by a vehicle associated with another computing device, wherein a driver account is accessible from the another computing device, and the method further comprises depositing a refund from the driver account for the transportation into the digital wallet account. Further details of the method 400 can be referred to FIGS. 1-3C above.

FIG. 4B illustrates a flowchart of an exemplary method 420 for providing digital wallet, according to various embodiments of the present disclosure. The method 420 may be implemented in various environments including, for example, the environment 100 of FIG. 1. The exemplary method 420 may be implemented by the computing device 110. The exemplary method 420 may be implemented by multiple systems similar to the system 102. The operations of method 420 presented below are intended to be illustrative. Depending on the implementation, the exemplary method 420 may include additional, fewer, or alternative steps performed in various orders or in parallel.

Block 422 comprises transmitting, by a computing device, information of a transportation to a server, the information comprising at least one of: a starting time of the transportation, an ending time of the transportation, an origin of the transportation, or a destination of the transportation, to cause the server to determine at least one of: the starting time is within the first time range, the ending time is within the second time range, the origin is within the origin location range, or the destination is within the destination location range. Block 424 comprises in response to receiving an allowance from the server, using at least a portion of a credit from a digital wallet account for defraying the transportation's cost.

In some embodiments, transmitting the origin of the transportation comprises transmitting a Global Positioning System (GPS) position of the computing device corresponding to a pick-up location of the transportation.

In some embodiments, the method further comprises displaying an option for paying a first portion of the transportation's cost from the digital wallet account and a second portion of the transportation's cost from a personal payment account. Further details of the method 420 can be referred to FIGS. 1-3C above.

The techniques described herein are implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

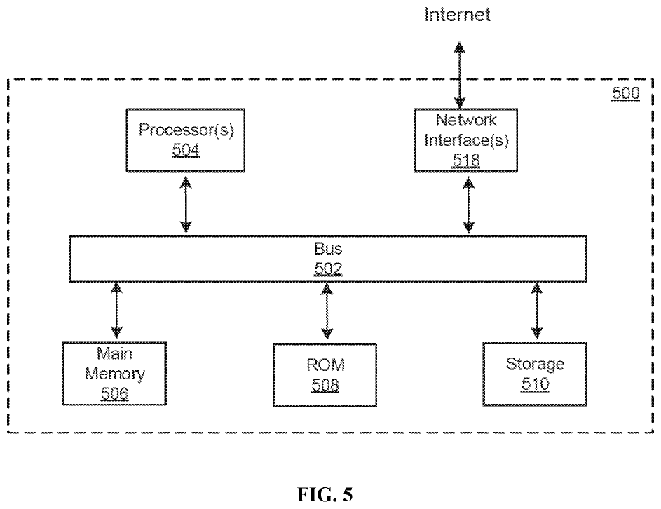

FIG. 5 is a block diagram that illustrates a computer system 500 upon which any of the embodiments described herein may be implemented. The system 500 may correspond to the system 102 described above. The computer system 500 includes a bus 502 or other communication mechanism for communicating information, one or more hardware processors 504 coupled with bus 502 for processing information. Hardware processor(s) 504 may be, for example, one or more general purpose microprocessors. The processor(s) 504 may correspond to the processor 104 described above.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions. The main memory 506, the ROM 508, and/or the storage 510 may correspond to the memory 106 described above.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The main memory 506, the ROM 508, and/or the storage 510 may include non-transitory storage media. The term “non-transitory media,” and similar terms, as used herein refers to a media that store data and/or instructions that cause a machine to operate in a specific fashion. The media excludes transitory signals. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 500 also includes a network interface 518 coupled to bus 502. Network interface 518 provides a two-way data communication coupling to one or more network links that are connected to one or more local networks. For example, network interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

The computer system 500 can send messages and receive data, including program code, through the network(s), network link and network interface 518. In the Internet example, a server might transmit a requested code for an application program through the Internet, the ISP, the local network and the network interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented engines may be located in a single geographic location (e.g., within a home environment, an office environment, or a server farm). In other exemplary embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method for providing digital wallet, comprising:
obtaining, from a computing device, information of a transportation, the information including at least one of; a starting time of the transportation, an ending time of the transportation, an origin of the transportation, or a destination of the transportation;
performing at least one of a comparison of the starting time with a first time range, a comparison of the ending time with a second time range, a comparison of the origin with an origin location range, or a comparison of the destination with a destination location range; and
in response to determining at least one of; the starting time is within the first time range, the ending time is within the second time range, the origin is within the origin location range, or the destination is within the destination location range, allowing the computing device to use at least a portion of a credit from a digital wallet account for defraying the transportation's cost.

2. The method of claim 1, wherein the obtaining the origin of the transportation includes:
obtaining a Global Positioning System (GPS) position of the computing device corresponding to a pick-up location of the transportation.

3. The method of claim 1, wherein the obtaining the destination of the transportation includes:
obtaining a GPS location of another computing device associated with a vehicle providing the transportation corresponding to a drop-off location of the transportation.

4. The method of claim 1, further comprising:
determining a recipient of the portion of the credit; and
in response to determining that the recipient is not associated with a provider of the transportation, preventing the computing device from using the portion of the credit.

5. The method of claim 1, before the obtaining, from the computing device, the information of the transportation, further comprising:
issuing the credit from a master account to the digital wallet account accessible from the computing device, wherein the credit is associated with at least one of the first time range, the second time range, the origin location range, or the destination location range.

6. The method of claim 5, wherein:
the credit is not usable beyond an effective time period; and
the method further comprises: when the effective time period expires, returning a remaining amount of the credit in the digital wallet account to the master account.

7. The method of claim 5, wherein:
the master account is associated with an enterprise entity; and
the first time range, the second time range, the origin location range, and the destination location range are configured by the enterprise entity.

8. The method of claim 1, wherein:
the digital wallet account and a personal payment account are accessible through the computing device; and
allowing the computing device to use the at least a portion of the credit for defraying the transportation's cost comprises providing options through the computing device to pay for the transportation's cost from at least one of the digital wallet account or the personal payment account.

9. The method of claim 8, wherein the providing options through the computing device to pay for the transportation's cost from at least one of the digital wallet account or the personal payment account comprises:
providing an option for paying a first portion of the transportation's cost from the digital wallet account and a second portion of the transportation's cost from the personal payment account.

10. The method of claim 8, wherein:
in response to determining that a remaining amount of the credit in the digital wallet account is less than the transportation's cost, drawing the remaining amount to pay for a part of the transportation's cost and drawing a balance of the transportation's cost from the personal payment account.

11. The method of claim 8, wherein the allowing the computing device to use the at least a portion of the credit for defraying the transportation's cost includes:
allowing the computing device to defray the transportation's cost with the credit for no more than a threshold.

12. The method of claim 8, wherein:
the transportation is provided by a vehicle associated with another computing device, wherein a driver account is accessible from the another computing device; and
the method further comprises depositing a refund from the driver account for the transportation into the digital wallet account.

13. A digital wallet system, comprising a processor and a non-transitory computer-readable storage medium storing instructions that, when executed by the processor, cause the processor to perform a method, the method comprising:
obtaining, from a computing device, information of a transportation, the information including at least one of; a starting time of the transportation, an ending time of the transportation, an origin of the transportation, or a destination of the transportation;
performing at least one of a comparison of the starting time with a first time range, a comparison of the ending time with a second time range, a comparison of the origin with an origin location range, or a comparison of the destination with a destination location range; and
in response to determining at least one of; the starting time is within the first time range, the ending time is within the second time range, the origin is within the origin location range, or the destination is within the destination location range, allowing the computing device to use at least a portion of a credit from a digital wallet account for defraying the transportation's cost.

14. The system of claim 13, wherein the obtaining the origin of the transportation includes:
obtaining a Global Positioning System (GPS) position of the computing device corresponding to a pick-up location of the transportation.

15. The system of claim 13, wherein the obtaining the destination of the transportation includes:
obtaining a GPS location of another computing device associated with a vehicle providing the transportation corresponding to a drop-off location of the transportation.

16. The system of claim 13, wherein before the obtaining, from the computing device, the information of the transportation, the method further comprises:
issuing the credit from a master account to the digital wallet account accessible from the computing device, wherein the credit is associated with at least one of; the first time range, the second time range, the origin location range, or the destination location range.

17. The system of claim 13, wherein:
the digital wallet account and a personal payment account are accessible through the computing device; and
allowing the computing device to use the at least a portion of the credit for defraying the transportation's cost comprises providing options through the computing device to pay for the transportation's cost from at least one of the digital wallet account or the personal payment account.

18. A computer-implemented method for providing digital wallet, comprising:
transmitting, by a computing device, information of a transportation to a server, the information including at least one of a starting time of the transportation, an ending time of the transportation, an origin of the transportation, or a destination of the transportation, to cause the server to determine at least one of; the starting time is within the first time range, the ending time is within the second time range, the origin is within the origin location range, or the destination is within the destination location range; and
in response to receiving an allowance from the server, using at least a portion of a credit from a digital wallet account for defraying the transportation's cost.

19. The method of claim 18, wherein the transmitting the origin of the transportation includes:
transmitting a Global Positioning System (GPS) position of the computing device corresponding to a pick-up location of the transportation.

20. The method of claim 18, further comprising:
displaying an option for paying a first portion of the transportation's cost from the digital wallet account and a second portion of the transportation's cost from a personal payment account.
